(19) United States
(12) Patent Application Publication
(10) Pub. No.: US 2020/0366795 A1
(43) Pub. Date: Nov. 19, 2020

(54) IMAGE FORMING APPARATUS THAT DISPLAYS WARNING MESSAGE WHEN DESTINATION OF PART DOES NOT COINCIDE WITH DESTINATION OF APPARATUS BODY

(71) Applicant: KYOCERA Document Solutions Inc., Osaka (JP)

(72) Inventor: Tomohiro TAKAHASHI, Osaka (JP)

(73) Assignee: KYOCERA Document Solutions Inc., Osaka (JP)

(21) Appl. No.: 16/872,728

(22) Filed: May 12, 2020

(30) Foreign Application Priority Data
May 16, 2019 (JP) 2019-093155

(51) Int. Cl. H04N 1/00; G06K 7/10

(52) U.S. Cl. CPC H04N 1/0048; G06K 7/10366; H04N 1/00408

(57) ABSTRACT

An image forming apparatus includes an attachment member, an information obtaining device, a storage device, an image forming device, a display, and a control device. The control device obtains, by using a second conversion method, first destination information from identification information and first information. The identification information and first information are obtained by the information obtaining device from a storage medium mounted on a part attached to an apparatus body through the attachment member. When the obtained first destination information does not coincide with second destination information stored in the storage device, the control device causes the display to display a warning message showing that an improper part is attached.

### INCORPORATION BY REFERENCE

This application claims priority to Japanese Patent Application No. 2019-093155 filed on 16 May 2019, the entire contents of which are incorporated by reference herein.

### BACKGROUND

The present disclosure relates to an image forming apparatus, and particularly relates to a technique for judging a proper part.

In image forming apparatuses, there is a known technology for judging when a part containing a coloring material such as toner or ink is attached to a main body whether the part attached is a proper one or not.

For example, there is a known conventional image forming in which, when information such as toner color, destination, and toner type is read by a reading sensor from a memory mounted on a cartridge being attached to the apparatus body, based on the information that has been read, checks whether a specification of the mounted cartridge coincides with a preset specification. Upon determining that a process cartridge of a different specification is attached, the known conventional image forming apparatus displays an error message on a display panel.

### SUMMARY

A technique improved over the above technique is proposed as one aspect of the present disclosure.

An image forming apparatus includes an attachment member, an information obtaining device, a storage device, an image forming device, a display, and a control device. The attachment member is configured to removably attach a part containing a coloring material to an apparatus body. The information obtaining device obtains, from a storage medium mounted on the part being attached to the apparatus body through the attachment member, identification information on the part and first information. The first information is generated using the identification information and first destination information in accordance with a predetermined first conversion method, and the first destination information indicates a destination of the part. The storage device stores second destination information indicating a destination of the apparatus body and a second conversion method. The second conversion method is predetermined for obtaining the identification information and the first destination information from the first information. The image forming device uses the coloring material contained in the part being attached to the apparatus body and forms an image on a recording medium. The control device includes a processor and, when the processor executes a control program, acts as a controller. The controller is configured to: obtain the first destination information by using the second conversion method stored in the storage device, from the identification information and the first information that are obtained by the information obtaining device; and, when the obtained first destination information does not coincide with the second destination information stored in the storage device, cause the display to display a warning message showing that an improper part is attached.

### BRIEF DESCRIPTION OF THE DRAWINGS

FIG. 1 is a front sectional view showing an image forming apparatus according to one embodiment of the present disclosure.

FIG. 2 is a block diagram showing an internal configuration of the image forming apparatus.

FIG. 3 is a flowchart showing proper part judgement processing.

FIG. 4 is a diagram for explaining an example of the proper part judgement processing.

FIG. 5 is a diagram for explaining another example of the proper part judgement processing.

### DETAILED DESCRIPTION

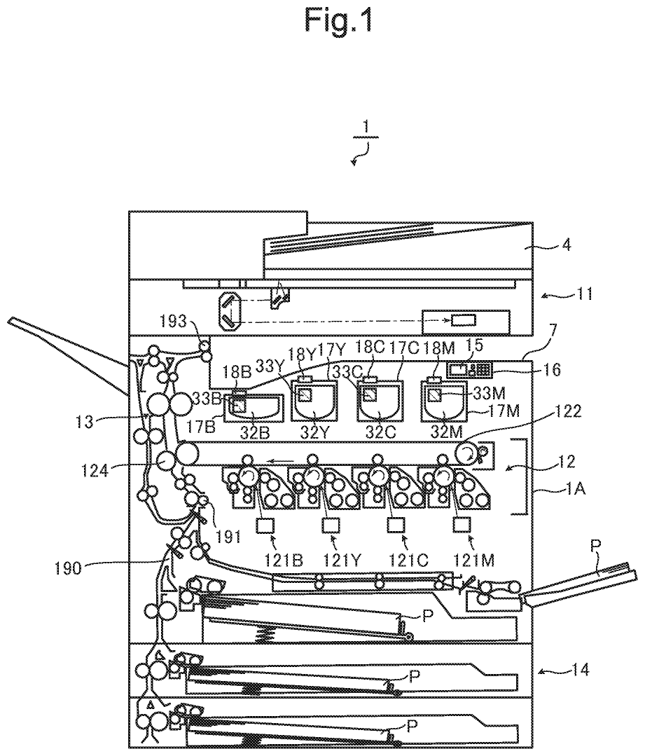

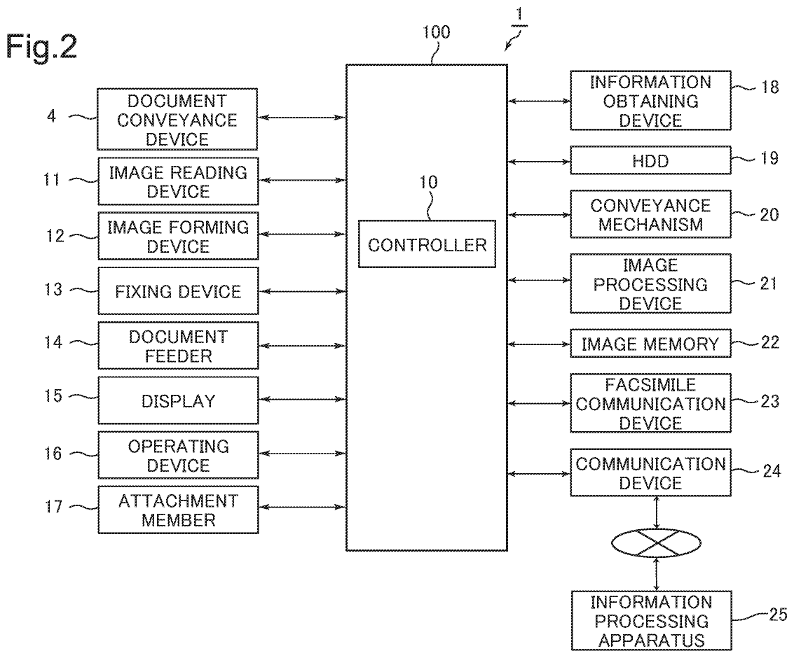

Hereinafter, a description will be given of an image forming apparatus according to an embodiment of the present disclosure, with reference to the drawings. Hereinafter, “coloring material” is used to indicate toner or ink. FIG. 1 is a front sectional view showing the image forming apparatus according to one embodiment of the present disclosure. FIG. 2 is a block diagram showing an internal configuration of the image forming apparatus.

### Configuration of Image Forming Apparatus 1

As shown in FIG. 1, the image forming apparatus 1 is a multifunctional peripheral having multiple functions such as a facsimile function, a copy function, a printer function, and a scanner function. The image forming apparatus 1 includes an image reading device 11, an image forming device 12, a fixing device 13, a document feeder 14, a display 15, an operating device 16, attachment members 17B, 17Y, 17C, and 17M, information obtaining devices 18B, 18Y, 18C, and 18M, and so on. Hereinafter, when collectively referring to the attachment members 17B, 17Y, 17C, and 17M, they are simply noted as “attachment member 17”, and when collectively referring to the information obtaining devices 18B, 18Y, 18C, and 18M, they are simply noted as “information obtaining device 18”.

The image reading device 11 is an auto document feeder (ADF) including a document conveyance device 4 that conveys an original document placed on an original document table and a scanner that optically reads the original document conveyed by the document conveyance device 4 or an original document placed on a platen glass. The image reading device 11 irradiates the original document with light using a lighting part and receives the reflected light at a charge-coupled device (CCD) censor, thus reading an image from the original document. Image data is thereby generated.

The image forming device 12 includes an image forming unit 121B for black, an image forming unit 121Y for yellow, an image forming unit 121C for cyan, an image forming unit 121M for magenta, an intermediate transfer belt 122, and a secondary transfer roller 124. Hereinafter, when collectively referring to the image forming units 121B, 121Y, 121C, and 121M, they are simply noted as “image forming unit 121”. The image forming unit 121 includes a photosensitive drum, a charging device, an exposure device, a developing device, and a transfer device.

Based on, for example, the image data generated by the image reading device 11, the image forming units 121B, 121Y, 121C, and 121M form toner images of respective colors and transfer the formed toner images of respective colors in a manner being superposed onto a surface of the intermediate transfer belt 122. The secondary transfer roller 124 transfers the color toner image formed on the surface of the intermediate transfer belt 122 onto a recording sheet P conveyed from the document feeder 14 through a conveyance path 190.

The fixing device 13 applies heat and pressure to the recording sheet P onto which the toner image has been formed by the image forming device 12, and fixes the toner image on the recording sheet P. The recording sheet P on which the toner image has been fixed by the fixing device 13 is outputted to an output tray 7.

The document feeder 14 has a manual feed tray and sheet feed cassettes. The document feeder 14 pulls out, one by one, recording sheets P contained in one of the sheet feed cassettes or recording sheets P placed on the manual feed tray, then feeds the pulled out recording sheets P toward the image forming device 12.

The display 15 is for example a display device composed with a liquid crystal display. The display 15 displays various screens related to various functions executable by the image forming apparatus 1.

The operating device 16 includes a plurality of hard keys, such as a start key for instructing the start of execution of the various functions. The operating device 16 also includes a touch panel that is placed over the display 15. The user inputs, via the operating device 16, various information such as instructions on the various kinds of functions executable by the image forming apparatus 1.

To an apparatus body 1A of the image forming apparatus 1, a toner container 32B containing toner for black, a toner container 32Y containing toner for yellow, a toner container 32C containing toner for cyan, and a toner container 32M containing toner for magenta are removably attached, respectively by the attachment members 17B, 17Y, 17C, and 17M. Hereinafter, when collectively referring to the toner containers 32B, 32Y, 32C, and 32M, they are simply noted as “toner container 32”.

The attachment member 17 has the detector for detecting whether the toner container 32 being attached to the attachment member 17 exists or not. The detector is not particularly limited as long as it is a commonly used detector, and a reflection type photo sensor or a transmission type photo sensor can be used. When there is no toner container 32 being attached to the attachment member 17, the detector outputs a first signal indicating that the toner container 32 is not being attached to the attachment member 17. When there is the toner container 32 being attached to the attachment member 17, the detector outputs a second signal indicating that the toner container 32 is attached to the attachment member 17.

The toner container 32 has a conveyance member formed with a screw and so on. The conveyance member is electrically connected by the attachment member 17 to a drive device, such as a motor, provided in the apparatus body 1A. By controlling operation of the drive device, the controller 10 controls operation of the conveyance member so that the toner contained in the toner container 32 is to be supplied to the developing device provided in the image forming unit 121 of the corresponding color. This allows the image forming device 12 to form an image on a recording sheet using the toner contained in the toner container 32 being attached to the apparatus body 1A.

The toner containers 32B, 32Y, 32C, and 32M have radio frequency (RF) tags 33B, 33Y, 33C, and 33M, respectively. Hereinafter, when collectively referring to the RF tags 33B, 33Y, 33C, and 33M, they are simply noted as “RF tag 33”. The RF tag 33 includes a memory, a control circuit, and an antenna.

A memory of the RF tag 33 stores identification (ID) that serves a role as identification information for identifying the toner container 32. Also, the memory stores first information generated using the ID of the toner container 32 and first destination information in accordance with a predetermined first conversion method, the first destination information indicating a destination of the toner container 32. For example, the ID and the first information are registered to the RF tag 33 via a writing device for radio frequency identification (RFID) by a sender of the toner container 32 when the toner container 32 is shipped to the destination.

The ID is not particularly limited, and a reflection type photosensor or a transmission type photosensor can be used. Here, the ID is defined as a character string composed of a plurality of numbers individually assigned to for each of the toner containers 32B, 32Y, 32C, and 32M. The first destination information is not particularly limited, but here, the first destination information is defined as a character string indicating the destination of the toner container 32. For example, when the destination is “Japan”, the first destination information indicates the character string “JPN”. Furthermore, when the destination is “United States Of America”, the first destination information indicates the character string “USA”.

The first conversion method is not particularly limited, but here, it uses a conversion method that includes a first method and a second method: the first method generates a first character string by arranging numbers included in the character string that form the ID and characters included in the character string that form the first destination information alternately one by one in order from the beginning; and the second method generates a second character string (serving a role as the first information) by reversing the order of the numbers and the characters included in the generated first character string from the beginning to the end.

For example, if the ID is the character string “123” and the first destination information is the character string “USA”, at first, the first character string “1U2S3A” is generated in accordance with the first method. Then, as the first information, the second character string “A3S2U1” is generated from the generated first character string in accordance with the second method.

The control circuit of the RF tag 33 is activated when a first radio wave transmitted from the information obtaining device 18 is received via the antenna, and transmits the ID and the first information, which are stored in the memory, on a second radio wave to the information obtaining device 18 via the antenna.

The information obtaining device 18 is a reading device for the RFID and performs wireless communication with the RF tag 33 existing in a communicable range. The information obtaining device 18 includes a control circuit and an antenna. The information obtaining device 18 transmits the first radio wave via the antenna and receives the second radio wave transmitted from the RF tag 33 (of the passive method, for example) that has received the first radio wave, to thereby obtain the ID and the first information that are stored in the RF tag 33.

The information obtaining device 18B is attached to a position at which the RF tag 33B will come to exist in the communicable range of the information obtaining device 18B in a state where the toner container 32B is being attached to the apparatus body 1A by the attachment member 17B. Similarly, when each of the toner containers 32Y, 32C, and 32M is being attached to the apparatus body 1A via each of the attachment members 17Y, 17C, and 17M, the information obtaining devices 18Y, 18C, and 18M are attached to positions respectively at which the RF tags 33Y, 33C, and 33M will come to exist in the communicable ranges of each of the information obtaining devices 18Y, 18C, and 18M.

As shown in FIG. 2, the image forming apparatus 1 includes the control device 100. The control device 100 includes a processor, a random access memory (RAM), a read only memory (ROM), and so on. The processor is, for example, a central processing unit (CPU), a micro processing unit (MPU), or an application specific integrated circuit (ASIC).

The control device 100 acts as the controller 10 when a control program stored in a built-in ROM or in a hard disk drive (HDD) 19 is executed by the processor. The controller 10 may not be implemented by the operation in accordance with the control program but may be constituted by a hardware circuit.

The control device 100 is electrically connected with the document conveyance device 4, the image reading device 11, the image forming device 12, the fixing device 13, the document feeder 14, the display 15, the operating device 16, the attachment member 17, the information obtaining device 18, the HDD 19, a conveyance mechanism 20, an image processing device 21, an image memory 22, a facsimile communication device 23, a communication device 24, and so on.

The conveyance mechanism 20 is formed by a transport roller pair 191, a discharge roller pair 193, and so on. Under the control of the controller 10, the transport mechanism 20 conveys the recording sheet P along the conveyor path 190 and discharges the recording sheet P to the output tray 7.

The HDD 19 is a large storage device and stores various data such as the image data generated by the image reading device 11. The HDD 19 stores various control programs for realizing generic operation of the image forming apparatus 1. As one of the aforesaid various control programs, the HDD 19 stores a control program for executing proper part judgement processing according to the one embodiment of the present disclosure.

The HDD 19 stores in advance second destination information indicating the destination of the apparatus body 1A of the image forming apparatus 1. The second destination information is not particularly limited, but here, the second destination information is defined as a character string indicating the destination of the apparatus body 1A. For example, the second destination information is registered via the operating device 16 by a sender of the apparatus body 1A when the apparatus body 1A is shipped to the destination.

Also, the HDD 19 stores a predetermined second conversion method. In accordance with the second conversion method, the controller 10 obtains from the first information the ID of the toner container 32 and the first destination information. The second conversion method is not particularly limited, but here, it uses a conversion method that includes a third method and a fourth method: the third method generates a third character string by reversing the order of the numbers and the characters included in the character string indicated by the first information from the beginning to the end; and the fourth method generates a fourth character string by extracting numbers line up in odd-numbered positions from the numbers and the characters included in the third character string and arranging them in ascending order, and generates a fifth character string by extracting characters line up in even-numbered positions and arranging them in ascending order.

For example, if the second character string, which serves the role as the first information, is “A3S2U1”, at first, the controller 10 generates the third character string “1U2S3A” in accordance with the third method. Then, in accordance with the fourth method, the controller 10 generates, from the generated third character string, the fourth character string “123” and also generates the fifth character string “USA”.

The image processing device 21 executes image processing as needed for the image data generated by the image reading device 11.

The image memory 22 includes an area for temporarily storing the image data, the image data being an image formation target and generated by the image reading device 11.

The facsimile communication device 23 connects to a public line and transmits and receives image data via the public line.

The communication device 24 includes a communication module such as a local area network (LAN) board. The image forming apparatus 1 performs data communication via the communication device 24 with an information processing apparatus 25 connected through the network.

Each component of the image forming apparatus 1 is connected to a power source. When power is supplied from the power source, each component of the image forming apparatus 1 is operated.

Operation

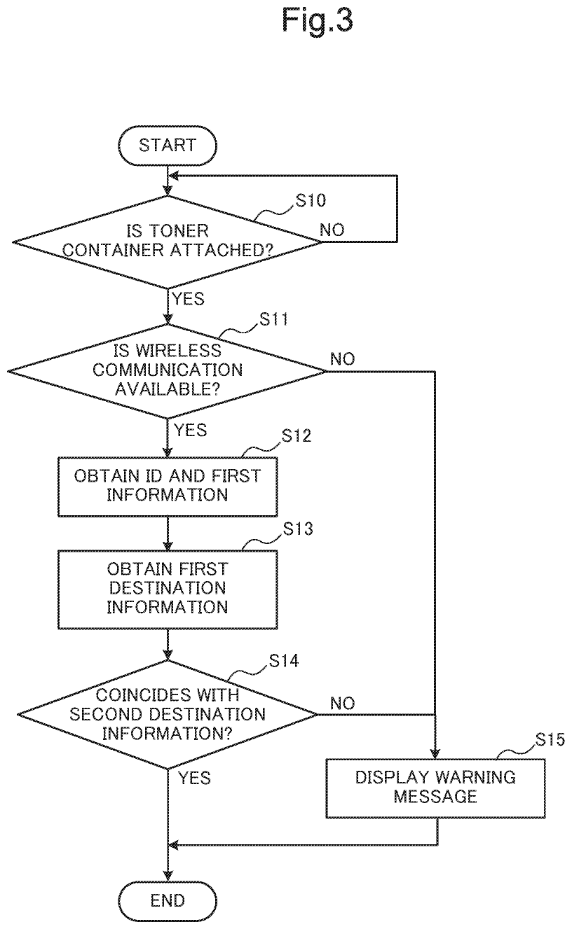

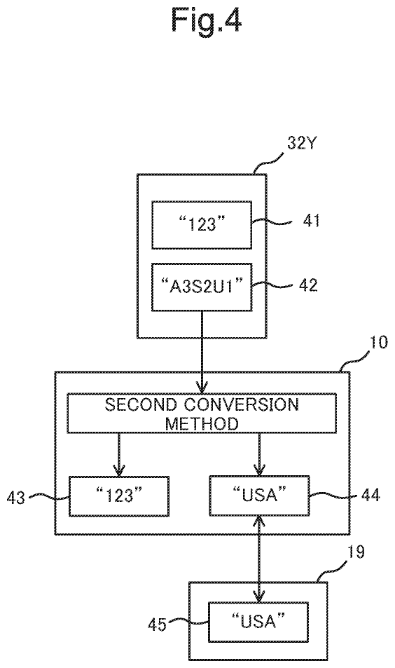

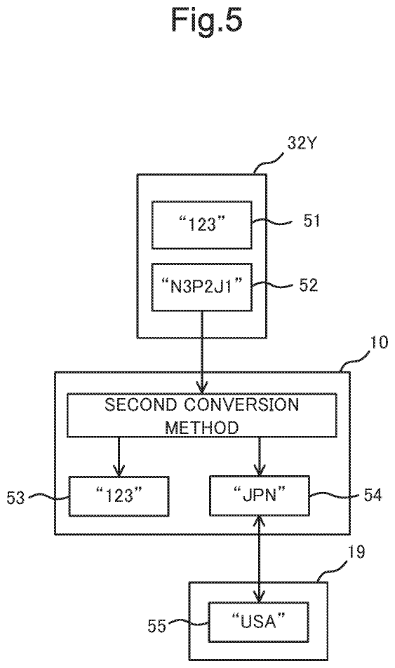

The operation of the image forming apparatus 1 when the toner container 32Y is attached to the apparatus body 1A will be described below. FIG. 3 is a flowchart showing the proper part judgement processing. FIG. 4 and FIG. 5 are diagrams for explaining examples of the proper part judgement processing. The controller 10 starts executing the proper part judgement processing when the power of the image forming apparatus 1 is turned on.

In the proper part judgement processing, until the controller 10 detects that the signal outputted from the detector of the attachment member 17Y is changed from the first signal to the second signal, the controller 10 repeats the processing of judging that the toner container 32Y is not being attached to the apparatus body 1A (NO at step S10).

### Case Where Destination of Toner Container 32Y is “United States Of America”

Suppose that in order to replace the toner container 32Y, the user removes the used toner container 32Y from the apparatus body 1A, and attaches an unused toner container 32Y to the apparatus body 1A by the attachment member 17Y. Here, with reference to FIG. 4, suppose that the memory of the RF tag 33Y mounted on the unused toner container 32Y stores ID 41 indicating the character string “123”, and stores the first information 42 indicating the character string “A3S2U1”.

When detecting that the signal outputted from the detector of the attachment member 17Y is changed from the first signal to the second signal, the controller 10 determines that the toner container 32Y is attached to the apparatus body 1A (YES at step S10), then determines whether the wireless communication with the RF tag 33Y mounted on the toner container 32Y is available or not (step S11).

To be specific, when the controller 10 causes the information obtaining device 18Y to transmit the first radio wave, and when the information obtaining device 18Y receives the second radio wave transmitted from the RF tag 33Y in response to the first radio wave within a predetermined time from a transmission time of the first radio wave, the controller 10 determines that the wireless communication with the RF tag 33Y is available. On the other hand, when the information obtaining device 18Y does not receive the second radio wave within the predetermined time from the transmission time of the first radio wave, the controller 10 determines that the wireless communication with the RF tag 33Y is not available.

In this case, when the controller 10 causes the information obtaining device 18Y to transmit the first radio wave, the control circuit of the RF tag 33Y is activated upon receiving the first radio wave, and transmits, on the second radio wave, the ID and the first information that are stored in the memory to the information obtaining device 18 within the predetermined time from the transmission time of the first radio wave. When the information obtaining device 18Y receives the second radio wave within the predetermined time from the transmission time of the first radio wave, the controller 10 determines that the wireless communication with the RF tag 33Y is available (YES at step S11), and obtains the ID and the first information from the received second radio wave (step S12). After obtaining the ID and the first information, the controller 10 obtains the first destination information from the obtained ID and the first information by using the second conversion method being stored in the HDD 19 (step S13).

To be specific, the controller 10 performs arithmetic processing in accordance with the third method of the second conversion method, and generates the third character string “1U2S3A” from the obtained first information 42 “A3S2U1”. The controller 10 performs arithmetic processing in accordance with the fourth method of the second conversion method, and generates the fourth character string 43 “123” from the generated third character string and also generates the fifth character string 44 “USA”. From the generated fourth character string 43 and the fifth character string 44, the controller 10 obtains, as the ID of the toner container 32Y, the fourth character string 43 that coincides with the obtained ID and obtains, as the first destination information, the fifth character string 44 that does not coincide with the obtained ID.

After obtaining the first destination information, the controller 10 judges whether or not the obtained first destination information coincides with the second destination information being stored in the HDD 19 (step S14). As shown in FIG. 4, when the destination of the apparatus body 1A is “United States Of America” and the character string indicated by the second destination information 45 stored in the HDD 19 is “USA”, the controller 10 determines that the first destination information coincides with the second destination information (YES at step S14) and ends the proper part judgement processing.

Case where Destination of Toner Container 32Y is “Japan”

Suppose that in order to replace the toner container 32Y, the user removes the used toner container 32Y from the apparatus body 1A, and attaches an unused toner container 32Y to the apparatus body 1A by the attachment member 17Y. Here, with reference to FIG. 5, suppose that the memory of the RF tag 33Y mounted on the unused toner container 32Y stores ID 51 indicating the character string “123”, and stores the first information 52 indicating the character string “N3P2J1”.

When detecting that the signal outputted from the detector of the attachment member 17Y is changed from the first signal to the second signal, the controller 10 determines that the toner container 32Y is attached to the apparatus body 1A (YES at step S10), then determines whether the wireless communication with the RF tag 33Y mounted on the toner container 32Y is available or not (step S11).

In this case, when the controller 10 causes the information obtaining device 18Y to transmit the first radio wave, the control circuit of the RF tag 33Y is activated upon receiving the first radio wave, and transmits, on the second radio wave, the ID and the first information that are stored in the memory to the information obtaining device 18 within the predetermined time from the transmission time of the first radio wave. When the information obtaining device 18Y receives the second radio wave within the predetermined time from the transmission time of the first radio wave, the controller 10 determines that the wireless communication with the RF tag 33Y is available (YES at step S11), and obtains the ID and the first information from the received second radio wave (step S12). After obtaining the ID and the first information, the controller 10 obtains the first destination information from the obtained ID and the first information by using the second conversion method being stored in the HDD 19 (step S13).

To be specific, the controller 10 performs arithmetic processing in accordance with the third method of the second conversion method, and generates the third character string “1J2P3N” from the obtained first information 52 “N3P2J1”. The controller 10 performs arithmetic processing in accordance with the fourth method of the second conversion method, and generates the fourth character string 53 “123” from the generated third character string and also generates the fifth character string 54 “JPN”. From the generated fourth character string 53 and the fifth character string 54, the controller 10 obtains, as the ID of the toner container 32Y, the fourth character string 53 that coincides with the obtained ID and obtains, as the first destination information, the fifth character string 54 that does not coincide with the obtained ID.

After obtaining the first destination information, the controller 10 judges whether or not the obtained first destination information coincides with the second destination information being stored in the HDD 19 (step S14). As shown in FIG. 5, when the character string indicated by the second destination information 55 stored in the HDD 19 is “USA”, the controller 10 determines that the first destination information does not coincide with the second destination information (NO at step S14) and causes the display 15 to display the warning message such as “improper toner container is attached” to show that an improper toner container 32Y is attached (step S15).

Furthermore, when, for example, the RF tag 33Y is not mounted on the attached toner container 32Y and the information obtaining device 18Y does not receive the second radio wave within the predetermined time from the transmission time of the first radio wave, the controller 10 determines that the wireless communication with the RF tag 33Y is not available (NO at step S11), and executes the aforesaid processing at step S15. After the display of the warning message, the controller 10 ends the proper part judgement processing.

The operation of the image forming apparatus 1 when the toner containers 32B, 32C, and 32M are being attached to the apparatus body 1A is performed similarly as the aforesaid case where the operation of the image forming apparatus 1 when the toner container 32Y is being attached to the apparatus body 1A.

In a case where the proper parts are different for each destination, if a coloring material contained in a part whose destination does not coincide with the destination of the apparatus body is used, there are risks that the quality of the image will be degraded and that the image forming apparatus will malfunction.

The aforementioned conventional image forming apparatus simply uses the technology that displays an error message when the specification of the part attached is not the same as the specification set beforehand, and the technology cannot solve the above problem.

In contrast, in this embodiment, the controller 10 obtains, by using the second conversion method being stored in the HDD 19, the first destination information from the ID and the first information of the toner container 32Y that are obtained by the information obtaining device 18Y. When the obtained first destination information does not coincide with the second destination information stored in the HDD 19, the controller 10 causes the display 15 to display the warning message showing that the improper toner container 32Y is being attached.

As described above, when the first destination information does not coincide with the second destination information, the warning message is displayed. Thus, in the case where the proper toner containers are different for each destination, it can prevent the toner contained in the toner container whose destination does not coincide with the destination of the apparatus body from being used. Accordingly, it is possible to prevent the risks such as deterioration in the image quality and malfunction of the image forming apparatus caused by use of the aforesaid toner.

Furthermore, according to the above embodiment, when the wireless communication with the RF tag 33Y is not available, in other words, when the ID and the first information of the toner container 32Y cannot be obtained from the RF tag 33Y by the information obtaining device 18Y, the controller 10 causes the display 15 to display the warning message. This will prevent the use of the toner contained in the improper toner container when, for example, the attached toner container 32Y is the improper toner container to which the RF tag 33Y is not mounted. Accordingly, it is possible to prevent the risks such as deterioration in the image quality and malfunction of the image forming apparatus caused by use of the aforesaid toner.

Still further, according to the above embodiment, when the toner container 32Y is attached to the apparatus body 1A by the attachment member 17Y, the controller 10 causes the information obtaining device 18Y to obtain the ID and the first information of the toner container 32Y. With such configuration, for example, in replacing the toner container 32Y, the warning message is displayed if the first destination information does not coincide with the second destination information. Thus, in the case where the proper toner containers are different for each destination, it is possible to prevent the toner contained in the toner container whose destination does not coincide with the destination of the apparatus body from being used. Accordingly, it is possible to more reliably prevent the risks such as deterioration in the image quality and malfunction of the image forming apparatus caused by use of the aforesaid toner.

### Other Modifications

In the above embodiment, the controller 10 causes the display 15 to display the warning message in the processing at step S15. The present disclosure is not limited to such embodiment. For example, the controller 10 may be configured such that while causing the display 15 to display the waring message in the processing at step S15, the image formation by the image forming apparatus 12 is prohibited.

This will forbid the image formation by the image forming apparatus 12 when the first destination information does not coincide with the second destination information, so that in the case where the proper toner containers are different for each destination, it can reliably prevent the toner contained in the toner container whose destination does not coincide with the destination of the apparatus body from being used. Accordingly, it is possible to more reliably prevent the risks such as deterioration in the image quality and malfunction of the image forming apparatus caused by use of the aforesaid toner.

In the above embodiment, the second destination information was registered by the sender of the image forming apparatus 1, but the present disclosure is not limited to such the embodiment. For example, it may be configured such that the image forming apparatus 1 is provided with a global positioning system (GPS) function and by using the GPS function, the controller 10 finds out the location of the apparatus body 1A of the image forming apparatus 1, and sets, as the second destination information, the character string corresponding to the found location.

In the above embodiment, the reading device for the RFID is used as the information obtaining device 18, but the present disclosure is not limited to such the embodiment. For example, a reading device for an integrated circuit (IC) chip may be used as the information obtaining device 18. In this case, as a storage medium, an IC chip storing the ID and the first information is mounted on the toner container 32.

In the above embodiment, the character string composed of numbers was used as the ID, but the present disclosure is not limited to such the embodiment. For example, as the ID, a character string composed of characters may be used and also, a character string composed of numbers and characters may be used.

In the above embodiment, the character string composed of characters was used as the first and the second destination information, but the present disclosure is not limited to such the embodiment. For example, as the first and the second destination information, a character string composed of numbers may be used and also, a character string composed of numbers and characters may be used.

In the above embodiment, the toner container 32 was used as the part containing the coloring material, but the present disclosure is not limited to such the embodiment. For example, as the part containing the coloring material, an ink cartridge containing ink may be used. In that case, the image forming apparatus 1 is provided with an ink jet image forming device instead of the image forming device 12 and the fixing device 13.

The ink jet image forming device has four record heads each corresponding to yellow, magenta, cyan, and black. Based on the image data generated by the image reading device 11, the ink jet image forming device forms an image of each color on a recording sheet by ejecting inks of the corresponding colors using a nozzle that each of the four recording heads has.

Further, in the above embodiment, the image forming device 12 and other components formed an image on the recording sheet, but the present disclosure is not limited to such the embodiment. The image forming device 12 and other components may be configured to form the image on different recording media other than the recording paper. Examples of the different recording media include an overhead projector (OHP) sheet.

The present disclosure is not limited to the above embodiments and can be modified in various ways. For example, although descriptions of the above embodiments are given taking a color multifunction peripheral as an example of the image forming apparatus according to the present disclosure, the example is merely illustrative and the image forming apparatus may be a monochrome multifunction peripheral, a printer copier, and a facsimile machine.

The configurations and processing of the foregoing embodiments and variations detailed above with reference to FIG. 1 to FIG. 5 are merely exemplary, and not intended to limit the present disclosure to the configurations and processing.

While the present disclosure has been described in detail with reference to the embodiments thereof, it would be apparent to those skilled in the art the various changes and modifications may be made therein within the scope defined by the appended claims.

What is claimed is:

1. An image forming apparatus comprising:
an attachment member configured to removably attach a part containing a coloring material to an apparatus body;
an information obtaining device that obtains, from a storage medium mounted on the part being attached to the apparatus body through the attachment member, identification information on the part and first information, the first information being generated using the identification information and first destination information in accordance with a predetermined first conversion method, the first destination information indicating a destination of the part;
a storage device that stores second destination information indicating a destination of the apparatus body and a second conversion method, the second conversion method being predetermined for obtaining the identification information and the first destination information from the first information;
an image forming device that uses the coloring material contained in the part being attached to the apparatus body and forms an image on a recording medium;
a display; and
a control device that includes a processor and, when the processor executes a control program, acts as a controller configured to:
obtain the first destination information by using the second conversion method stored in the storage device, from the identification information and the first information that are obtained by the information obtaining device; and
when the obtained first destination information does not coincide with the second destination information stored in the storage device, cause the display to display a warning message showing that an improper part is attached.

2. The image forming apparatus according to claim 1, wherein when the obtained first destination information does not coincide with the second destination information stored in the storage device, the controller prohibits the image forming device from forming the image.

3. The image forming apparatus according to claim 1, wherein when the information obtaining device cannot obtain the identification information and the first information from the storage medium, the controller causes the display to display the warning message.

4. The image forming apparatus according to claim 1, wherein when the part is attached to the apparatus body through the attachment member, the controller causes the information obtaining device to obtain the identification information and the first information.

5. The image forming apparatus according to claim 3, wherein
the information obtaining device is a reading device that performs wireless communication with an RF tag mounted on the part, and
when the controller causes the information obtaining device to transmit a first radio wave and the information obtaining device does not receive, within a predetermined time from a transmission time of the first radio wave, a second radio wave transmitted from the RF tag in response to the first radio wave, the controller causes the display to display the warning message.
